(19) United States
(12) Patent Application Publication
(10) Pub. No.: US 2026/0252358 A1
(43) Pub. Date: Aug. 27, 2026

(54) SERVER SPREAD-SPECTRUM METHOD AND SYSTEM, ELECTRONIC DEVICE, AND READABLE MEDIUM

(71) Applicant: SUZHOU METABRAIN INTELLIGENT TECHNOLOGY CO., LTD., Suzhou, Jiangsu (CN)

(72) Inventor: Liliang TIAN, Suzhou, Jiangsu (CN)

(21) Appl. No.: 18/876,928

(22) PCT Filed: Dec. 25, 2023
(86) PCT No.: PCT/CN2023/141618

§ 371 Date: Dec. 19, 2024

(30) Foreign Application Priority Data
Feb. 8, 2023 (CN) 202310087217.X

(51) Int. Cl. G06F 9/4401; G06F 11/22

(52) U.S. Cl. CPC G06F 9/4401; G06F 11/2273

(57) ABSTRACT

A spread spectrum method and system for a server, and an electronic device and a non-transitory readable storage medium are provided by embodiments of the present application. By determining a spread spectrum amplitude and a spread spectrum form which are required by a configuration component in the server and a spread spectrum amplitude and a spread spectrum form which are required by the server, and generating mapping information, wherein the mapping information is determined based on an electromagnetic radiation frequency when there is a configuration component that generates electromagnetic interference, whether the configuration component is in place needs to only be determined at first startup; and when the configuration component is in place, spread spectrum is mandatorily enabled, spread spectrum function of the server is not required to be manually enabled.

### CROSS-REFERENCE TO RELATED APPLICATION

This application claims the priority of the Chinese Patent application filed on Feb. 8^{th}, 2023 before the China National Intellectual Property Administration with the application number of 202310087217.X, and the title of “SERVER SPREAD-SPECTRUM METHOD AND SYSTEM, ELECTRONIC DEVICE, AND READABLE MEDIUM”, which is incorporated herein in its entirety by reference.

### FIELD

The present application relates to the technical field of servers and, more particularly, to a spread spectrum method for a server, a spread spectrum system for a server, an electronic device, and a non-transitory computer-readable storage medium.

### BACKGROUND

In a design process of conventional servers by a server manufacturer, components in the servers may have a problem of electromagnetic radiation interference, so as not to meet a factory standard. In order to solve the problem of electromagnetic radiation interference, all shipped model machines are required to enable a spread spectrum function. However, after the spread spectrum function is enabled, the product may have a product performance problem, and system performance may decrease. Therefore, when clock spread spectrum is introduced, how to balance enabling of spread spectrum and disabling of spread spectrum is always a difficulty in the industry.

### SUMMARY

A spread spectrum method, system, and apparatus for a server, an electronic device, and a non-transitory computer-readable storage medium are provided by embodiments of the present application, to solve the problem that system performance may decrease when clock spread spectrum is introduced to the server.

A spread spectrum method for a server is provided by the embodiments of the present application. The server includes at least one configuration component, and the method includes:
determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency;
writing the mapping information into a basic input output system program;
in response to the server being powered on, determining a configuration component, having an electromagnetic radiation frequency exceeding a preset electromagnetic radiation threshold, in the server to be a target configuration component; and
according to the mapping information that is written into the basic input output system program, determining the spread spectrum amplitude and the spread spectrum form which correspond to the target configuration component, and enabling a spread spectrum function for the target configuration component.

In some embodiments, the method further includes:
in response to the server being powered on, determining the configuration component, having the electromagnetic radiation frequency exceeding the preset electromagnetic radiation threshold, in the server to be the target configuration component; and
according to the mapping information that is written into the basic input output system program, determining the spread spectrum amplitude and the spread spectrum form which correspond to the server, and enabling a spread spectrum function for the server.

In some embodiments, after the step of according to the mapping information that is written into the basic input output system program, determining the spread spectrum amplitude and the spread spectrum form which correspond to the server, and enabling the spread spectrum function for the server, the method further includes:
setting a menu item for enabling and disabling spread spectrum in the basic input output system program.

In some embodiments, after the step of according to the mapping information that is written into the basic input output system program, determining the spread spectrum amplitude and the spread spectrum form which correspond to the target configuration component, and enabling the spread spectrum function for the target configuration component, the method further includes:
setting a menu item for enabling and disabling spread spectrum in the basic input output system program.

In some embodiments, the method further includes:
when the server is powered on, in response to determining that the target configuration component does not exist in the server, setting the menu item for enabling and disabling spread spectrum in the basic input output system program.

In some embodiments, the method further includes:
manually enabling or disabling spread spectrum through the menu item.

In some embodiments, the server has an integrated input/output (IIO) port; the IIO port is connected to different configuration components; and the method further includes:
by automatically scanning the IIO port, determining, in a cross validation way, whether the configuration component connected to the IIO port is the target configuration component.

In some embodiments, the spread spectrum form includes up spread, center spread and down spread.

A spread spectrum method for a server is further provided by the embodiments of the present application, wherein the server includes at least one configuration component; the configuration component has identification information; and the method includes:
determining a spread spectrum amplitude and a spread spectrum form which are required by each of the at least one configuration component in the server and a spread spectrum amplitude and a spread spectrum form which are required by the server, and generating mapping information according to the identification information the spread spectrum amplitudes and the spread spectrum forms corresponding to the at least one configuration component, wherein the mapping information is determined based on an electromagnetic radiation frequency;
writing the mapping information into a basic input output system program;
in response to the server being powered on, according to the identification information, determining a configuration component, having an electromagnetic radiation frequency exceeding a preset electromagnetic radiation threshold, in the server to be a target configuration component; and
according to the mapping information that is written into the basic input output system program, determining the spread spectrum amplitude and the spread spectrum form which correspond to the target configuration component, and enabling a spread spectrum function for the target configuration component.

In some embodiments, the method further includes:
in response to the server being powered on, determining the configuration component, having the electromagnetic radiation frequency exceeding the preset electromagnetic radiation threshold, in the server to be the target configuration component; and according to the mapping information that is written into the basic input output system program, determining the spread spectrum amplitude and the spread spectrum form which correspond to the server, and enabling a spread spectrum function for the server.

In some embodiments, after the step of according to the mapping information that is written into the basic input output system program, determining the spread spectrum amplitude and the spread spectrum form which correspond to the server, and enabling the spread spectrum function for the server, the method further includes:
setting a menu item for enabling and disabling spread spectrum in the basic input output system program.

In some embodiments, after the step of according to the mapping information that is written into the basic input output system program, determining the spread spectrum amplitude and the spread spectrum form which correspond to the target configuration component, and enabling the spread spectrum function for the target configuration component, the method further includes:
setting a menu item for enabling and disabling spread spectrum in the basic input output system program.

In some embodiments, the method further includes:
when the server is powered on, in response to determining that the target configuration component does not exist in the server, setting the menu item for enabling and disabling spread spectrum in the basic input output system program

A spread spectrum method for a server is further provided by the embodiments of the present application, wherein the server includes at least one configuration component, and the method includes:
setting different preset electromagnetic radiation thresholds for different shipping locations;
determining a spread spectrum amplitude and a spread spectrum form which correspond to each of the at least one configuration component in the server and a spread spectrum amplitude and a spread spectrum form which correspond to the server, and generating mapping information, wherein the mapping information is determined based on an electromagnetic radiation frequency;
writing the mapping information into a basic input output system program;
in response to the server being powered on, determining whether a configuration component having an electromagnetic radiation frequency exceeding the electromagnetic radiation threshold exists in the server; and
in response to the configuration component having the electromagnetic radiation frequency exceeding the electromagnetic radiation threshold existing in the server, according to the mapping information that is written into the basic input output system program, determining the spread spectrum amplitude and the spread spectrum form which correspond to the server, and enabling a spread spectrum function for the server.

A spread spectrum system for a server is further provided by the embodiments of the present application, the spread spectrum system for the server includes a clock generator and a clock buffer, wherein an output end of the clock generator is connected to an input end of the clock buffer; an output end of the clock buffer is connected to a configuration component which does not generate electromagnetic interference in the server; the output end of the clock generator is further connected to a configuration component which generates electromagnetic interference in the server; and
the clock generator is configured to spread a clock signal generated by the clock generator by changing an input signal of the clock generator.

In some embodiments, the clock generator is connected to a direct-current voltage through a plurality of resistors; and a voltage of the input signal of the clock generator is changed by changing connection relationships among the plurality of resistors.

In some embodiments, the clock generator is connected to the direct-current voltage through a slide rheostat; and the voltage of the input signal of the clock generator is changed by changing a resistance value of the slide rheostat.

In some embodiments, the clock buffer has an input end and a plurality of output ends; and an outputting channel of the clock signal is spread through the clock buffer.

In some embodiments, the clock generator is further connected to a crystal oscillator.

An electronic device is further provided by the embodiments of the present application, the electronic device includes: a processor, a communication interface, a memory and a communication bus, wherein the processor, the communication interface and the memory complete mutual communications through the communication bus;
the memory is configured to store a computer program; and
the processor is configured to in response to executing the computer program stored on the memory, implement the method according to the embodiments of the present application.

One or more non-transitory computer-readable storage media are provided by the embodiments of the present application, which have instructions stored thereon, wherein the instructions, in response to being executed by one or more processors, cause the one or more processors to implement the method according to the embodiments of the present application.

The embodiments of the present application include the following advantages: by testing whether a configuration component that generates electromagnetic interference exists in a server, if it is tested that the configuration component that generates electromagnetic interference exists in the server, product identification information of the configuration component is written into a preset basic input output system program in the server. Based on a preset electromagnetic radiation condition, a spread spectrum amplitude and a spread spectrum form which are required by the server are determined, and the spread spectrum amplitude and the spread spectrum form are written into the basic input output system program. When the server is powered on, the server automatically scans whether the basic input output system program records the product identification information corresponding to the configuration component which generates electromagnetic interference. If the basic input output system program records the product identification information corresponding to the configuration component which generates electromagnetic interference, for the configuration component which generates electromagnetic interference, a spread spectrum function is enabled using the spread spectrum amplitude and the spread spectrum form which are recorded in the basic input output system program. Thus, if there is a configuration component that generates electromagnetic interference, whether the configuration component is in place is only required to be determined at the first startup. If the configuration component is in place, spread spectrum is mandatorily enabled, spread spectrum function of the server is not required to be manually enabled.

### BRIEF DESCRIPTION OF THE DRAWINGS

FIG. 1 is a flowchart of steps of a spread spectrum method for a server according to an embodiment of the present application;

FIG. 2 is a schematic diagram of a corresponding relationship between a peripheral component interface express (PCIe) signal and a frequency;

FIG. 3a shows a shielding mode and a shielding effectiveness thereof;

FIG. 3b shows another shielding mode and a shielding effectiveness thereof;

FIG. 4 is a comparison diagram of electromagnetic radiations before and after enabling a spread spectrum function;

FIG. 5 is a flowchart of a spread spectrum method for a server according to an embodiment of the present application;

FIG. 6 is a flowchart of steps of another spread spectrum method for a server according to an embodiment of the present application;

FIG. 7 is a flowchart of another spread spectrum method for a server according to an embodiment of the present application;

FIG. 8 is a flowchart of steps of another spread spectrum method for a server according to an embodiment of the present application;

FIG. 9 is a flowchart of another spread spectrum method for a server according to an embodiment of the present application;

FIG. 10 is a flowchart of steps of another spread spectrum method for a server according to an embodiment of the present application;

FIG. 11 is a flowchart of another spread spectrum method for a server according to an embodiment of the present application;

FIG. 12A is a structural diagram of a spread spectrum system for a server according to an embodiment of the present application;

FIG. 12B is a structural diagram of another spread spectrum system for a server according to an embodiment of the present application;

FIG. 13 is a structural block diagram of a spread spectrum apparatus for a server according to an embodiment of the present application;

FIG. 14 is a block diagram of an electronic device according to an embodiment of the present application; and

FIG. 15 is a schematic diagram of a non-transitory computer-readable storage medium according to an embodiment of the present application.

### DETAILED DESCRIPTION

In order to make the above objects, features, and advantages of the present application more obvious and comprehensible, the present application will be further described in detail below in combination with the accompanying drawings and implementations.

Referring to FIG. 1, a flowchart of steps of a spread spectrum method for a server according to an embodiment of the present application is shown. The server includes at least one configuration component, and the method may include the following steps:
Step 101, determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency.

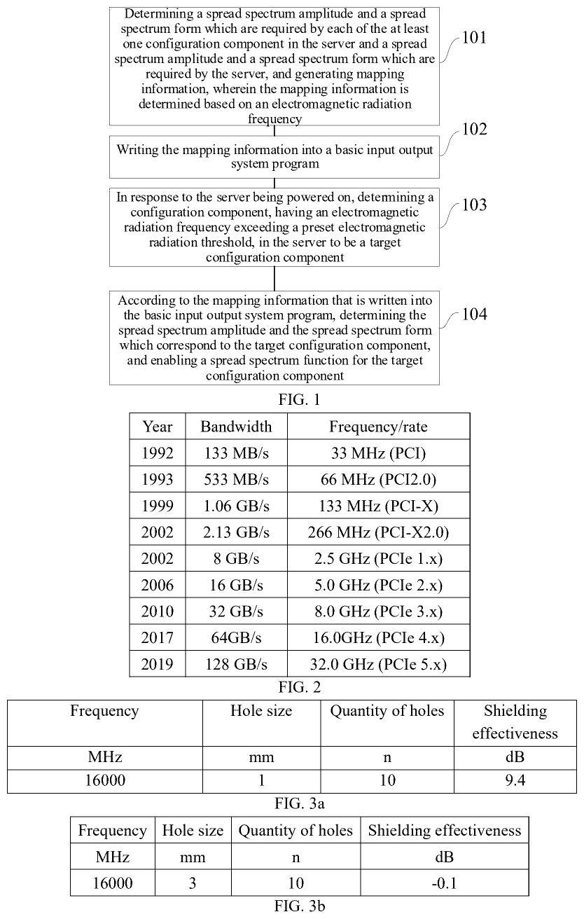

A spread-spectrum technique is a common wireless communication technique. When a clock generator on a motherboard operates, a peak value of a pulse may generate electromagnetic interference (EMI), and a spread spectrum technique may reduce the electromagnetic interference generated by a pulse generator. With the continuous increase in the operating speed and complexity of an electronic product, electromagnetic radiation of the product is also significantly increased. Commonly used methods for controlling the electromagnetic radiation include shielding, grounding, filtering, and the like. However, it is hard for the conventional methods to solve the problem that high-frequency signal radiation emission of servers exceeds the standard. A commonly used method for solving the problem that high-frequency signal radiation emission exceeds the standard is chassis shielding. However, with the advancement of technology, a signal frequency may further increase. As shown in FIG. 2, it shows a schematic diagram of a corresponding relationship between a peripheral component interconnect express (PCIe) signal and a frequency. A transmission rate of a Peripheral Component Interconnect (PCI) has increased from 33 MHz in 1992 to 2.5 GHz for PCIe 1.x in 2002, 5.0 GHz for PCIe 2.x, 8.0 GHz for PCIe 3.x, 16.0 GHz for PCIe 4.x, and 32.0 GHz for PCIe 5.x. It is more and more difficult to solve the problem of electromagnetic interference using the chassis shielding method.

In an example, PCIe 4.0 is taken as an example. A signal frequency of the PCIe 4.0 is 16 GHz. According to a calculation formula:
Formula 1: SE=20log(Wavelength/(2*Dimensio), wherein SE represents shielding effectiveness; Wavelength represents wavelength; Dimensio represents an aperture size;
Formula 2: SE=20log(speed_of_light/(2*frequency*Dimensio), wherein SE represents shielding effectiveness, speed_of_light represents a speed of light; frequency represents a frequency; Dimensio represents an aperture size;
Formula 3: n-holes=SE-20log(SQRT(n)), wherein n-holes represents a quantity of holes; SE represents shielding effectiveness; and SQRT represents a square root function.

As shown in FIG. 3a, a shielding mode and shielding effectiveness thereof are shown. As shown in FIG. 3b, another shielding method and shielding effectiveness thereof are shown. Therefore, for 16 GHz, when a shielding body has 10 holes with a diameter of 1 mm, the shielding effectiveness of the shielding body is 9.4 db. When a shielding body has 10 holes with a diameter of 3 mm, the shielding effectiveness of the shielding body is basically zero. Therefore, theoretically, it is not feasible to solve the problem of high-frequency radiation through a shielding technology for high-frequency signals similar to 16 GHz in PCIe 4.x. In a situation where it is difficult to implement the traditional shielding method, the problem of electromagnetic interference may be solved through a spread spectrum technique.

The server may include configuration components such as an OCP card (Ethernet card), a non-transitory memory (NVM) express (NVME), and a PCIe. When the server operates, if electromagnetic radiation frequencies of these configuration components are high, the normal operation of the server may be affected. Therefore, corresponding spread spectrum amplitudes and spread spectrum forms required by the configuration components and a corresponding spread spectrum amplitude and spread spectrum form required by the server may be determined in advance according to the electromagnetic radiation frequencies of the configuration components and the electromagnetic radiation frequency of the server, and mapping information may be generated according to corresponding relationships between the configuration components and the spread spectrum amplitudes, as well as the spread spectrum forms, and corresponding relationship between the server and the spread spectrum amplitude, as well as the spread spectrum form.
Step 102, writing the mapping information into a basic input output system program.

The basic input output system (BIOS) is a group of programs that are fixed onto a read only memory (ROM) on a motherboard in a computer. It stores the most important basic input output programs, a self-check program after startup, and a system self-start program, and may read and write information of system settings. A main function of the basic input output system is to provide the bottommost and most direct hardware settings and control for the computer. In addition, the BIOS further provides some system parameters to an operating system. Changes in system hardware are hidden by the BIOS, and programs use BIOS functions instead of directly controlling the hardware.

After the mapping information is generated, the mapping information may be written into a basic input output system program.
Step 103, in response to the server being powered on, determining a configuration component, having an electromagnetic radiation frequency exceeding a preset electromagnetic radiation threshold, in the server to be a target configuration component.

For the server, an electromagnetic radiation threshold is preset. When the server is powered on, the self-check program after startup in the BIOS is enabled, and may automatically detect an electromagnetic radiation frequency of a configuration component in the server. The configuration component, having the electromagnetic radiation frequency exceeding the preset electromagnetic radiation threshold, in the server is determined to be the target configuration component.
Step 104, according to the mapping information that is written into the basic input output system program, determining the spread spectrum amplitude and the spread spectrum form which correspond to the target configuration component, and enabling a spread spectrum function for the target configuration component.

If the BIOS detects that the target configuration component exists during startup, the spread spectrum amplitude and spread spectrum form corresponding to the target configuration component may be determined in the BIOS according to the mapping information, and the spread spectrum function may be enabled for the target configuration component based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.

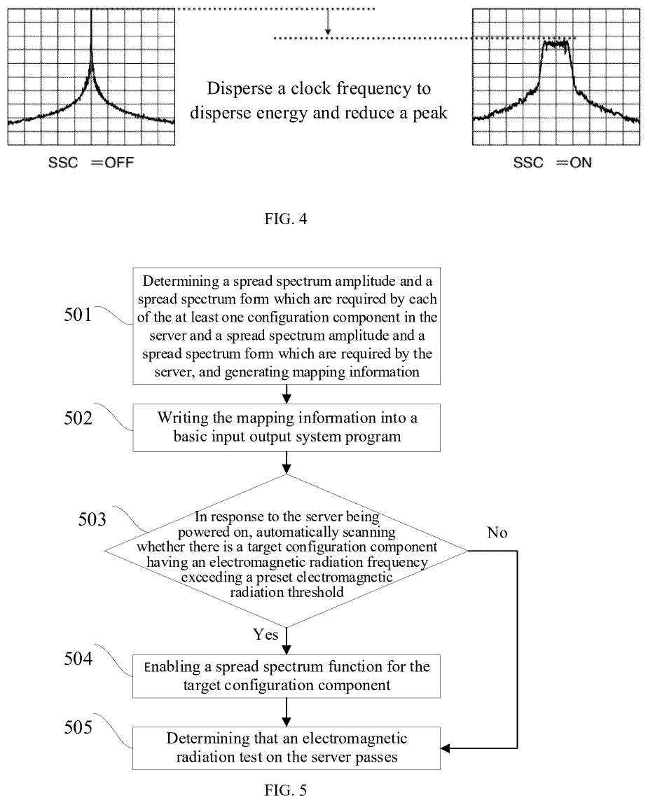

As shown in FIG. 4, a comparison diagram of electromagnetic radiations before and after enabling a spread spectrum function is shown. The left side shows disabling of the spread spectrum function (SSC=OFF), and the right side shows enabling of the spread spectrum function (SSC=ON). From FIG. 4, it may be seen that after the spread spectrum is enabled, a peak value of an electromagnetic radiation frequency is reduced, thereby a good effect of reducing electromagnetic interference is achieved.

FIG. 5 is a flowchart of a spread spectrum method for a server according to an embodiment of the present application, including the following steps:
Step 501, determining a spread spectrum amplitude and a spread spectrum form which are required by a configuration component in the server and a spread spectrum amplitude and a spread spectrum form which are required by the server, and generating mapping information;
Step 502, writing the mapping information into a basic input output system program;
Step 503, in response to the server being powered on, automatically scanning whether there is a target configuration component having an electromagnetic radiation frequency exceeding a preset electromagnetic radiation threshold; in response to there being the target configuration component having the electromagnetic radiation frequency exceeding the preset electromagnetic radiation threshold, executing step 504; in response to there being no target configuration component having the electromagnetic radiation frequency exceeding the preset electromagnetic radiation threshold, executing step 505;
Step 504, enabling a spread spectrum function for the target configuration component; and Step 505, determining that an electromagnetic radiation test on the server passes.

In the embodiment of the present application, by determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency; writing the mapping information into a basic input output system program; in response to the server being powered on, determining a configuration component, having an electromagnetic radiation frequency exceeding a preset electromagnetic radiation threshold, in the server to be a target configuration component; and according to the mapping information that is written into the basic input output system program, determining the spread spectrum amplitude and the spread spectrum form which correspond to the target configuration component, and enabling a spread spectrum function for the target configuration component, if there is a configuration component that generates electromagnetic interference, whether the configuration component is in place is only required to be determined at the first startup; and if the configuration component is in place, spread spectrum is mandatorily enabled, spread spectrum function of the server is not required to be manually enabled.

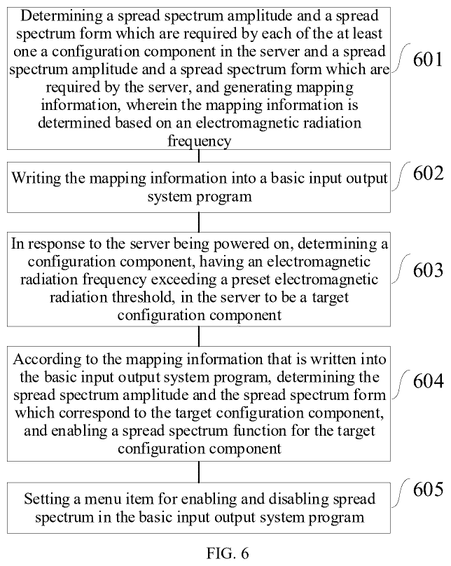

Referring to FIG. 6, a flowchart of steps of another spread spectrum method for a server according to an embodiment of the present application is shown. The server includes at least one configuration component, and the method may include the following steps:
Step 601, determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency.

The server may include configuration components such as an OCP card, an NVME, and a PCIe. When the server operates, if electromagnetic radiation frequencies of these configuration components are high, the normal operation of the server may be affected. Therefore, corresponding spread spectrum amplitudes and spread spectrum forms required by the configuration components and a corresponding spread spectrum amplitude and spread spectrum form required by the server may be determined in advance according to the electromagnetic radiation frequencies of the configuration components and the electromagnetic radiation frequency of the server, and mapping information may be generated according to corresponding relationships between the configuration components and the spread spectrum amplitudes, as well as the spread spectrum forms and a corresponding relationship between the server and the spread spectrum amplitude, as well as the spread spectrum form.
Step 602, writing the mapping information into a basic input output system program.

After the mapping information is generated, the mapping information may be written into a basic input output system program.

In the embodiment of the present application, the spread spectrum form includes up spread, center spread and down spread.

Spread spectrum may be classified into three forms: up spread, center spread and down spread. 16 GHz is taken as takes as an example below to respectively explain the forms of up spread, center spread and down spread.

In an example, 16 GHz and up spread 0.5% are taken as an example. Up spread is to spread energy of 16 GHz from 16 GHz to a spectrum range of 16 GHz to 16.08 GHz. Since the energy is spread, a clock frequency may be dispersed, the energy may be dispersed, and a radiation peak may be reduced.

16 GHz and center spread 0.5% are taken as an example. Center spread is to spread energy of 16 GHz from 16 GHz to a spectrum range of 15.92 GHz to 16.08 GHz. Since the energy is spread, a clock frequency may be dispersed, the energy may be dispersed, and a radiation peak may be reduced.

16 GHz and down spread 0.5% are taken as an example. Down spread is to spread energy of 16 GHz from 16 GHz to a spectrum range of 15.92 GHz to 16 GHz. Since the energy is spread, a clock frequency may be dispersed, the energy may be dispersed, and a radiation peak may be reduced.
Step 603, in response to the server being powered on, determining a configuration component, having an electromagnetic radiation frequency exceeding a preset electromagnetic radiation threshold, in the server to be a target configuration component.

For the server, an electromagnetic radiation threshold is preset. When the server is powered on, the self-check program after startup in the BIOS is enabled, and may automatically detect an electromagnetic radiation frequency of a configuration component in the server. The configuration component, having the electromagnetic radiation frequency exceeding the preset electromagnetic radiation threshold, in the server is determined to be the target configuration component.

In the embodiment of the present application, the server has an integrated I/O module (IIO) port. The IIO port is connected to different configuration components. The method further includes:
by automatically scanning the IIO port, determining, in a cross validation way, whether the configuration component connected to the IIO port is the target configuration component.

The integrated I/O module (IIO) port is configured in the server. Through the IIO port, the server may be connected to the configuration component such as the OCP card, the NVME, and the PCIe. After the server is powered on, all the IIO ports may be scanned by using the cross validation method to determine whether the target configuration component exists in the server.

In an example, the IIO ports connected to the OCP card and the NVME may be scanned in the server first. If there is a target configuration component, the IIO ports connected to the NVME and the PCIe may continue to be scanned. If there is a target configuration component, the IIO ports connected to the OCP card and the PCIe may continue to be scanned. If there is no target configuration component, it may be determined that the target configuration component is the NVME.
Step 604, according to the mapping information that is written into the basic input output system program, determining the spread spectrum amplitude and the spread spectrum form which correspond to the target configuration component, and enabling a spread spectrum function for the target configuration component.

If the BIOS detects that the target configuration component exists during startup, the spread spectrum amplitude and spread spectrum form corresponding to the target configuration component may be determined in the BIOS according to the mapping information, and the spread spectrum function may be enabled for the target configuration component based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.
Step 605, setting a menu item for enabling and disabling spread spectrum in the basic input output system program.

After the spread frequency function is enabled for the target configuration component, the menu item for enabling and disabling spread frequency may be set in the basic input output system program, so that when the server is subsequently powered on, regardless of whether there is a configuration component that generates electromagnetic interference, the spread spectrum function is configured through the menu item, without signal fluctuations, thereby a normal startup process of the server is ensured.

In the embodiment of the present application, the method further includes:
when the server is powered on, in response to determining that the target configuration component does not exist in the server, setting the menu item for enabling and disabling spread spectrum in the basic input output system program.

In the embodiment of the present application, when the server is powered on, the self-check program after startup in the BIOS is enabled, which may automatically detect the electromagnetic radiation frequency of the configuration component in the server and determine whether there is a target configuration component. If there is no target configuration component, the menu item for enabling and disabling spread frequency may be directly set in the basic input output system program to configure the spread spectrum function through the menu item, without signal fluctuation, thereby the stability of the system of the server is ensured.

In the embodiment of the present application, the method further includes:
manually enabling or disabling spread spectrum through the menu item.

In the embodiment of the present application, after the menu item for enabling and disabling the spread spectrum is set in the BIOS, spread spectrum may be manually enabled or disabled to ensure that the server pass electromagnetic radiation and system stability tests.

In the embodiment of the present application, the method further includes:
in response to the server being powered on, determining a configuration component, having an electromagnetic radiation frequency exceeding a preset electromagnetic radiation threshold, in the server to be a target configuration component.

For the server, an electromagnetic radiation threshold is preset. When the server is powered on, the self-check program after startup in the BIOS is enabled, and may automatically detect an electromagnetic radiation frequency of a configuration component in the server. The configuration component, having the electromagnetic radiation frequency exceeding the preset electromagnetic radiation threshold, in the server is determined to be the target configuration component.

According to the mapping information that is written into the basic input output system program, the spread spectrum amplitude and the spread spectrum form which correspond to the server are determined, and a spread spectrum function is enabled for the server.

If the BIOS detects that the target configuration component exists during startup, the spread spectrum amplitude and spread spectrum form corresponding to the server may be determined in the BIOS according to the mapping information, and the spread spectrum function may be enabled for the server based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.

In the embodiment of the present application, after the step of according to the mapping information that is written into the basic input output system program, determining the spread spectrum amplitude and the spread spectrum form which correspond to the server, and enabling a spread spectrum function for the server, the method further includes:
setting a menu item for enabling and disabling spread spectrum in the basic input output system program.

After the spread frequency function is enabled for the server, the menu item for enabling and disabling spread frequency may be set in the basic input output system program, so that when the server is subsequently powered on, regardless of whether there is a configuration component that generates electromagnetic interference, the spread spectrum function is configured through the menu item, without signal fluctuations, thereby a normal startup process of the server is ensured.

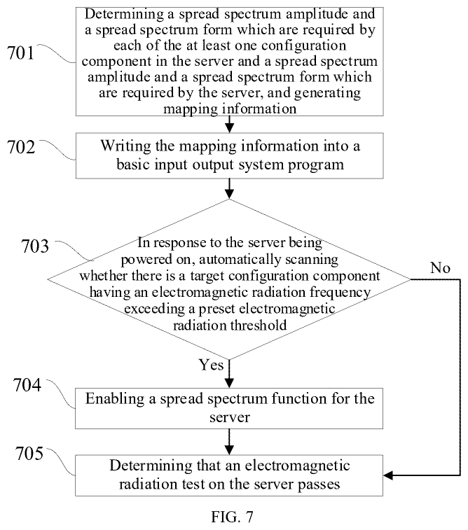

FIG. 7 is a flowchart of another spread spectrum method for a server according to an embodiment of the present application, including the following steps:
Step 701, determining a spread spectrum amplitude and a spread spectrum form which are required by a configuration component in the server and a spread spectrum amplitude and a spread spectrum form which are required by the server, and generating mapping information;
Step 702, writing the mapping information into a basic input output system program.
Step 703, in response to the server being powered on, automatically scanning whether there is a target configuration component having an electromagnetic radiation frequency exceeding a preset electromagnetic radiation threshold; if there is the target configuration component having the electromagnetic radiation frequency exceeding the preset electromagnetic radiation threshold, executing step 704; if there is no target configuration component having the electromagnetic radiation frequency exceeding the preset electromagnetic radiation threshold, executing step 705;
Step 704, enabling a spread spectrum function for the server; and
Step 705, determining that an electromagnetic radiation test on the server passes.

In the embodiment of the present application, by determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency; writing the mapping information into a basic input output system program; in response to the server being powered on, determining a configuration component, having an electromagnetic radiation frequency exceeding a preset electromagnetic radiation threshold, in the server to be a target configuration component; and according to the mapping information that is written into the basic input output system program, determining the spread spectrum amplitude and the spread spectrum form which correspond to the target configuration component, and enabling a spread spectrum function for the target configuration component, it is realized if there is a configuration component that generates electromagnetic interference, spread spectrum is mandatorily enabled; if there is no configuration component that generates electromagnetic interference, whether to enable spread spectrum is controlled through the menu item; whether the configuration component is in place is only required to be determined at the first startup; if the configuration component is in place, spread spectrum is mandatorily enabled; it is not necessary to configure an IIO port in advance in later stages to read information of the configuration component, so that the startup time is saved; spread spectrum is configured through the menu item regardless of whether the configuration component that generates electromagnetic interference exists, so that there are no signal fluctuations, and manual enabling of the spread spectrum function of the server is not required.

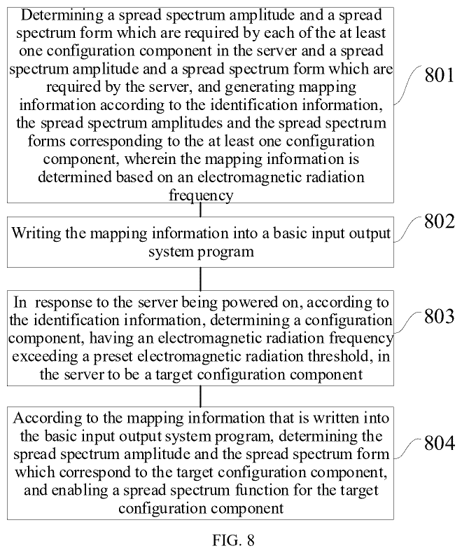

Referring to FIG. 8, a flowchart of steps of another spread spectrum method for a server according to an embodiment of the present application is shown. The server includes at least one configuration component, and the method may include the following steps:
Step 801, determining a spread spectrum amplitude and a spread spectrum form which are required by each of the at least one configuration component in the server and a spread spectrum amplitude and a spread spectrum form which are required by the server, and generating mapping information according to identification information, the spread spectrum amplitudes and the spread spectrum forms corresponding to the at least one configuration component, wherein the mapping information is determined based on an electromagnetic radiation frequency.

The server may include configuration components such as an OCP card, an NVME, and a PCIe, all of configuration components include corresponding identification information. By querying the identification information, the corresponding configuration components may be determined. In an example, product serial number codes (SN codes) may be used as product identification information. A product serial number is a concept introduced to verify a “legal identity of a product”, which is used for protecting the legitimate rights and interests of users and enabling users to enjoy legal services. A set of genuine products only corresponds to one group of product serial number codes.

When the server operates, if electromagnetic radiation frequencies of these configuration components are high, the normal operation of the server may be affected. Therefore, corresponding spread spectrum amplitudes and spread spectrum forms corresponding to the configuration components and a spread spectrum amplitude and spread spectrum form corresponding to the server may be determined in advance according to the electromagnetic radiation frequencies of the configuration components and the electromagnetic radiation frequency of the server, and mapping information may be generated according to the identification information corresponding to the configuration components, corresponding relationships between the configuration components and the spread spectrum amplitudes, as well as the spread spectrum forms, and a corresponding relationship between the server and the spread spectrum amplitude, as well as the spread spectrum form.
Step 802, writing the mapping information into a basic input output system program.

After the mapping information is generated, the mapping information may be written into a basic input output system program.
Step 803, in response to the server being powered on, according to the identification information, determining a configuration component, having an electromagnetic radiation frequency exceeding a preset electromagnetic radiation threshold, in the server to be a target configuration component.

For the server, an electromagnetic radiation threshold is preset. When the server is powered on, the self-check program after startup in the BIOS is enabled, and may automatically detect an electromagnetic radiation frequency of a configuration component in the server according to the identification information. The configuration component, having the electromagnetic radiation frequency exceeding the preset electromagnetic radiation threshold, in the server is determined to be the target configuration component.
Step 804, according to the mapping information that is written into the basic input output system program, determining the spread spectrum amplitude and the spread spectrum form which correspond to the target configuration component, and enabling a spread spectrum function for the target configuration component.

If the BIOS detects that the target configuration component exists during startup, the spread spectrum amplitude and spread spectrum form corresponding to the target configuration component may be determined in the BIOS according to the mapping information, and the spread spectrum function may be enabled for the target configuration component based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.

In the embodiment of the present application, by determining a spread spectrum amplitude and a spread spectrum form which are required by each of the at least one configuration component in the server and a spread spectrum amplitude and a spread spectrum form which are required by the server, and generating mapping information according to identification information, the spread spectrum amplitudes, and the spread spectrum forms corresponding to the at least one configuration component, wherein the mapping information is determined based on an electromagnetic radiation frequency; writing the mapping information into a basic input output system program; in response to the server being powered on, determining a configuration component, having an electromagnetic radiation frequency exceeding a preset electromagnetic radiation threshold, in the server to be a target configuration component according to the identification information; and according to the mapping information that is written into the basic input output system program, determining the spread spectrum amplitude and the spread spectrum form which correspond to the target configuration component, and enabling a spread spectrum function for the target configuration component, it is realized if there is a configuration component that generates electromagnetic interference, whether the configuration component is in place is only required to be determined at the first startup; and if the configuration component is in place, spread spectrum is mandatorily enabled, spread spectrum function of the server is not required to be manually enabled.

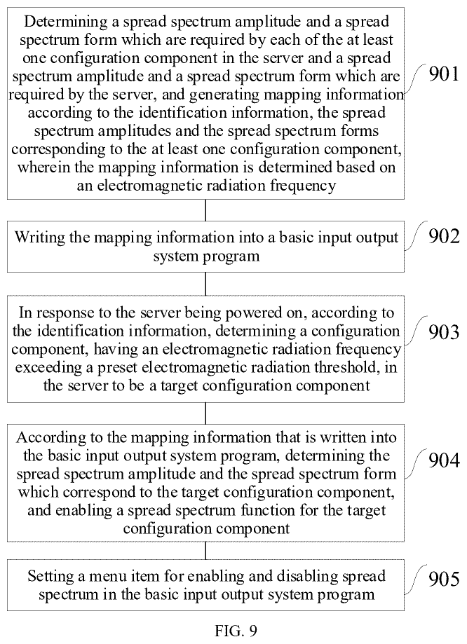

Referring to FIG. 9, a flowchart of steps of another spread spectrum method for a server according to an embodiment of the present application is shown. The server includes at least one configuration component, and the method may include the following steps:
Step 901, determining a spread spectrum amplitude and a spread spectrum form which are required by each of the at least one configuration component in the server and a spread spectrum amplitude and a spread spectrum form which are required by the server, and generating mapping information according to identification information, the spread spectrum amplitudes and the spread spectrum forms corresponding to the at least one configuration component, wherein the mapping information is determined based on an electromagnetic radiation frequency.

The server may include configuration components such as an OCP card, an NVME, and a PCIe, all of the configuration components include corresponding identification information. By querying the identification information, the corresponding configuration components may be determined. In an example, product serial number codes (SN codes) may be used as product identification information. A product serial number is a concept introduced to verify a “legal identity of a product”, which is used for protecting the legitimate rights and interests of users and enabling users to enjoy legal services. A set of genuine products only corresponds to one group of product serial number codes.

When the server operates, if electromagnetic radiation frequencies of these configuration components are high, the normal operation of the server may be affected. Therefore, spread spectrum amplitudes and spread spectrum forms corresponding to the configuration components and a spread spectrum amplitude and spread spectrum form corresponding to the server may be determined in advance according to the electromagnetic radiation frequencies of the configuration components and the electromagnetic radiation frequency of the server, and mapping information may be generated according to the identification information corresponding to the configuration components, corresponding relationships between the configuration components and the spread spectrum amplitudes, as well as the spread spectrum forms, and a corresponding relationship between the server and the spread spectrum amplitude, as well as the spread spectrum form.
Step 902, writing the mapping information into a basic input output system program.

After the mapping information is generated, the mapping information may be written into a basic input output system program.
Step 903, in response to the server being powered on, according to the identification information, determining a configuration component, having an electromagnetic radiation frequency exceeding a preset electromagnetic radiation threshold, in the server to be a target configuration component.

For the server, an electromagnetic radiation threshold is preset. When the server is powered on, the self-check program after startup in the BIOS is enabled, and may automatically detect an electromagnetic radiation frequency of a configuration component in the server according to the identification information. The configuration component, having the electromagnetic radiation frequency exceeding the preset electromagnetic radiation threshold, in the server is determined to be the target configuration component.
Step 904, according to the mapping information that is written into the basic input output system program, determining the spread spectrum amplitude and the spread spectrum form which correspond to the target configuration component, and enabling a spread spectrum function for the target configuration component.

If the BIOS detects that the target configuration component exists during startup, the spread spectrum amplitude and spread spectrum form corresponding to the target configuration component may be determined in the BIOS according to the mapping information, and the spread spectrum function may be enabled for the target configuration component based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.
Step 905, setting a menu item for enabling and disabling spread spectrum in the basic input output system program.

After the spread frequency function is enabled for the target configuration component, the menu item for enabling and disabling spread frequency may be set in the basic input output system program, so that when the server is subsequently powered on, regardless of whether there is a configuration component that generates electromagnetic interference, the spread spectrum function is configured through the menu item, without signal fluctuations, thereby a normal startup process of the server is ensured.

In the embodiment of the present application, the method further includes:
when the server is powered on, in response to determining that the target configuration component does not exist in the server, setting the menu item for enabling and disabling spread spectrum in the basic input output system program.

In the embodiment of the present application, when the server is powered on, the self-check program after startup in the BIOS is enabled, which may automatically detect the electromagnetic radiation frequency of the configuration component in the server and determine whether there is a target configuration component. If there is no target configuration component, the menu item for enabling and disabling spread frequency may be directly set in the basic input output system program to configure the spread spectrum function through the menu item, without signal fluctuation, thereby the stability of the system of the server is ensured.

In the embodiment of the present application, the method further includes:
in response to the server being powered on, determining a configuration component, having an electromagnetic radiation frequency exceeding a preset electromagnetic radiation threshold, in the server to be a target configuration component.

For the server, an electromagnetic radiation threshold is preset. When the server is powered on, the self-check program after startup in the BIOS is enabled, and may automatically detect an electromagnetic radiation frequency of a configuration component in the server. The configuration component, having the electromagnetic radiation frequency exceeding the preset electromagnetic radiation threshold, in the server is determined to be the target configuration component.

According to the mapping information that is written into the basic input output system program, the spread spectrum amplitude and the spread spectrum form which correspond to the server are determined, and a spread spectrum function is enabled for the server.

If the BIOS detects that the target configuration component exists during startup, the spread spectrum amplitude and spread spectrum form corresponding to the server may be determined in the BIOS according to the mapping information, and the spread spectrum function may be enabled for the server based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.

In the embodiment of the present application, after the step of according to the mapping information that is written into the basic input output system program, determining the spread spectrum amplitude and the spread spectrum form which correspond to the server, and enabling the spread spectrum function for the server, the method further includes:
setting a menu item for enabling and disabling spread spectrum in the basic input output system program.

After the spread frequency function is enabled for the server, the menu item for enabling and disabling spread frequency may be set in the basic input output system program, so that when the server is subsequently powered on, regardless of whether there is a configuration component that generates electromagnetic interference, the spread spectrum function is configured through the menu item, without signal fluctuations, thereby a normal startup process of the server is ensured.

In the embodiment of the present application, by determining a spread spectrum amplitude and a spread spectrum form which are required by each of the at least one configuration component in the server and a spread spectrum amplitude and a spread spectrum form which are required by the server, and generating mapping information according to the identification information, the spread spectrum amplitudes and the spread spectrum forms corresponding to the at least one configuration component, wherein the mapping information is determined based on an electromagnetic radiation frequency; writing the mapping information into a basic input output system program; in response to the server being powered on, determining a configuration component, having an electromagnetic radiation frequency exceeding a preset electromagnetic radiation threshold, in the server to be a target configuration component according to the identification information; and according to the mapping information that is written into the basic input output system program, determining the spread spectrum amplitude and the spread spectrum form which correspond to the target configuration component, and enabling a spread spectrum function for the target configuration component, it is realized if there is a configuration component that generates electromagnetic interference, spread spectrum is mandatorily enabled; if there is no configuration component that generates electromagnetic interference, whether to enable spread spectrum is controlled through the menu item; whether the configuration component is in place is only required to be determined at the first startup; if the configuration component is in place, spread spectrum is mandatorily enabled; it is not necessary to configure an IIO port in advance in later stages to read information of the configuration component, so that the startup time is saved; spread spectrum is configured through the menu item regardless of whether the configuration component that generates electromagnetic interference exists, so that there are no signal fluctuations, and manual enabling of the spread spectrum function of the server is not required.

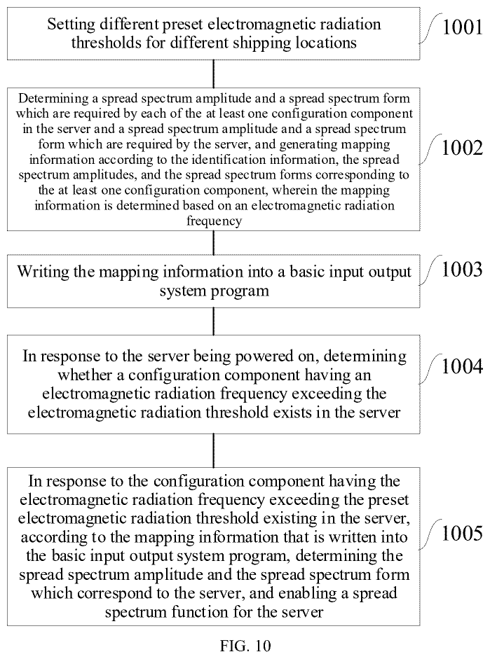

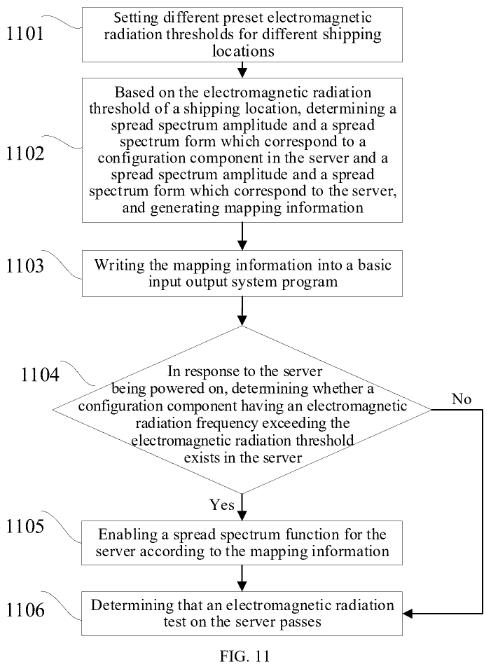

Referring to FIG. 10, a flowchart of steps of another spread spectrum method for a server according to an embodiment of the present application is shown. The server includes at least one configuration component, and the method may include the following steps:
Step 1001, setting different preset electromagnetic radiation thresholds for different shipping locations.

The server may include configuration components such as an OCP card, an NVME, and a PCIe. Electronic products all need to undergo electromagnetic compatibility certification when circulating in the market. However, in global certification, test frequency ranges for electromagnetic radiation are different. High frequency of electromagnetic radiation is taken an example, the high-frequency test frequency range in China (China Compulsory Certification (3C) certification) is 1 GHz-6 GHz; the high-frequency test frequency range in Europe (Conformité Européenne(CE) certification) is 1 GHz-6 GHz; and the high-frequency test frequency range in the United State (Federal Communications Commission (FCC) certification) is 1 GHz-18 GHz. Most other countries around the world follow the standard of Europe (CE certification), so that the high-frequency test range in the United States is not consistent with the high-frequency test ranges in other countries. In the embodiment of the present application, for different shipping locations, different electromagnetic radiation conditions may be set for the server.
Step 1002, determining a spread spectrum amplitude and a spread spectrum form which correspond to the configuration component in the server and a spread spectrum amplitude and a spread spectrum form which correspond to the server, and generating mapping information, wherein the mapping information is determined based on an electromagnetic radiation frequency.

When the server operates, if an electromagnetic radiation frequency of the configuration component is high, the normal operation of the server may be affected. Therefore, the corresponding spread spectrum amplitude and spread spectrum form required by the configuration component and a corresponding spread spectrum amplitude and spread spectrum form required by the server may be determined in advance according to the electromagnetic radiation frequency of the configuration component and an electromagnetic radiation frequency of the server, and mapping information may be generated according to corresponding relationships between the configuration components and the spread spectrum amplitudes, as well as the spread spectrum forms and a corresponding relationship between the server and the spread spectrum amplitude, as well as the spread spectrum form.
Step 1003, writing the mapping information into a basic input output system program.

After the mapping information is generated, the mapping information may be written into a basic input output system program.
Step 1004, in response to the server being powered on, determining whether a configuration component having an electromagnetic radiation frequency exceeding the electromagnetic radiation threshold exists in the server.

When the server is powered on, the self-check program after startup in the BIOS is enabled, and may automatically detect the electromagnetic radiation frequency of the configuration component in the server and determine whether the configuration component having the electromagnetic radiation frequency exceeding the preset electromagnetic radiation threshold exists in the server.
Step 1005, in response to the configuration component having the electromagnetic radiation frequency exceeding the preset electromagnetic radiation threshold existing in the server, according to the mapping information that is written into the basic input output system program, determining the spread spectrum amplitude and the spread spectrum form which correspond to the server, and enabling a spread spectrum function for the server.

If the BIOS detects that a target configuration component exists during startup, the spread spectrum amplitude and spread spectrum form corresponding to the server may be determined in the BIOS according to the mapping information, and the spread spectrum function may be enabled for the server based on the determined spread spectrum amplitude and spread spectrum form. By improving a BIOS startup identification sequence, the spread spectrum function is only enabled for a configuration component that generates electromagnetic interference. In this way, normal operation of a system function is also ensured while the spread spectrum is enabled.

FIG. 11 is a flowchart of another spread spectrum method for a server according to an embodiment of the present application, including the following steps:
Step 1101, setting different preset electromagnetic radiation thresholds for different shipping locations.
Step 1102, based on the electromagnetic radiation threshold of a shipping location, determining a spread spectrum amplitude and a spread spectrum form which correspond to a configuration component in the server and a spread spectrum amplitude and a spread spectrum form which correspond to the server, and generating mapping information.
Step 1103, writing the mapping information into a basic input output system program.
Step 1104, in response to the server being powered on, determining whether a configuration component having an electromagnetic radiation frequency exceeding the electromagnetic radiation threshold exists in the server; if the configuration component having the electromagnetic radiation frequency exceeding the electromagnetic radiation threshold exists in the server, executing step 1105; if no configuration component having the electromagnetic radiation frequency exceeding the electromagnetic radiation threshold exists in the server, executing step 1106.
Step 1105, enabling a spread spectrum function for the server according to the mapping information.
Step 1106, determining that an electromagnetic radiation test on the server passes.

In the embodiment of the present application, by setting different preset electromagnetic radiation thresholds for different shipping locations; determining a spread spectrum amplitude and a spread spectrum form which correspond to a configuration component in the server and a spread spectrum amplitude and a spread spectrum form which correspond to the server, and generating mapping information, wherein the mapping information is determined based on an electromagnetic frequency threshold; writing the mapping information into a basic input output system program; in response to the server being powered on, determining whether a configuration component having an electromagnetic radiation frequency exceeding the electromagnetic radiation threshold exists in the server; if the configuration component having the electromagnetic radiation frequency exceeding the electromagnetic radiation threshold exists in the server, according to the mapping information that is written into the basic input output system program, determining the spread spectrum amplitude and the spread spectrum form which correspond to the server; and enabling a spread spectrum function for the server, different electromagnetic radiation thresholds are set for different shipping locations. If there is a configuration component that generates electromagnetic interference, whether the configuration component is in place is only required to be determined at the first startup; and if the configuration component is in place, spread spectrum is mandatorily enabled, spread spectrum function of the server is not required to be manually enabled.

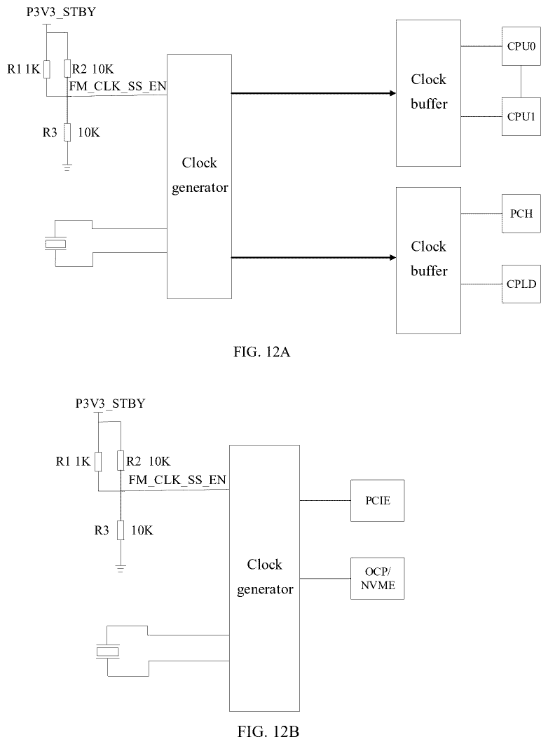

Referring to FIG. 12A, a structural diagram of a spread spectrum system for a server according to an embodiment of the present application is shown. Referring to FIG. 12B, a structural diagram of another spread spectrum system for a server according to an embodiment of the present application is shown.

The spread spectrum system for the server includes a clock generator and a clock buffer. An output end of the clock generator is connected to an input end of the clock buffer; an output end of the clock buffer is connected to a configuration component which does not generate electromagnetic interference in the server; and the output end of the clock generator is further connected to a configuration component which generates electromagnetic interference in the server.

The clock generator is configured to spread a clock signal generated by the clock generator by changing an input signal of the clock generator.

In the embodiment of the present application, the spread spectrum system for the server includes the clock generator (clk generator) and the clock buffer (clk buffer). A spread spectrum scheme for the server is generally to spread an FM_CLK_SS_EN signal of the clock generator. The FM_CLK_SS_EN signal is an input signal of the clock generator. By changing the FM_CLK_SS_EN signal of the clock generator, the FM_CLK_SS_EN signal may be spread, and the entire signal in the spread spectrum system for the server may be spread.

The output end of the clock generator is connected to the input end of the clock buffer, and a clock signal output from the output end of the clock generator serves as an input signal of the input end of the clock buffer. The output end of the clock buffer may be connected to a configuration component, which does not generate electromagnetic interference, in the server. In an example, as shown in FIG. 12A, if a processor, a complex programmable logic device, and other components of the server do not generate electromagnetic interference, these components are connected to the output end of the clock buffer. However, as shown in FIG. 12B, if a configuration component that generates electromagnetic interference exists in the server, such as an OCP card, an NVME, and a PCIe, the configuration component which generates electromagnetic interference may be connected to the output end of another clock generator in the server, and a separate clock generator may be used to provide a clock signal. In this way, it is ensured that the configuration component may satisfy an electromagnetic compatibility test and pass a systematic test, without enabling or disabling the spread spectrum function of the entire machine.

In the embodiment of the present application, the clock generator is connected to a direct-current voltage through a plurality of resistors; and a voltage of the input signal of the clock generator is changed by changing connection relationships among the plurality of resistors.

In the embodiment of the present application, the clock generator is provided with an input signal through a voltage signal of the direct-current voltage. The direct-current voltage may be P3V3_STBY. After the resistor R1 is connected in parallel to the resistor R2, the P3V3_STBY and the clock generator are respectively connected to two ends of the resistor R1. In the resistor R1, an end connected to the clock generator is also grounded through the resistor R3. In an example, a resistance value of R1 may be 1 kilo-ohm; a resistance value of the resistor R2 may be 10 kilo-ohms; and a resistance value of the resistor R3 may be 10 kilo-ohms.

In an example, a spread spectrum amplitude may be adjusted by adjusting the voltage of the FM_CLK_SS_EN signal. When R1 is loaded, R3 is loaded, and R2 is not loaded, down spread setting of −0.5% may be achieved. When R2 is loaded, R3 is loaded, and R1 is not loaded, down spread setting of −0.3% may be achieved.

In the embodiment of the present application, the clock generator is connected to the direct-current voltage through a slide rheostat; and the voltage of the input signal of the clock generator is changed by changing a resistance value of the slide rheostat.

In the spread spectrum system for the server, the clock generator may also be connected to the direct-current voltage through the slide rheostat, and an end of the slide rheostat connected to the clock generator is also grounded through resistor R3. The voltage of the input signal of the clock generator may be changed by changing the resistance value of the slide rheostat, to perform spread spectrum on the input signal. The voltage of the input signal of the clock generator may be randomly adjusted through the slide rheostat, thereby a more flexible spread spectrum scheme is provided.

In the embodiment of the present application, the clock buffer has an input end and a plurality of output ends; and an outputting channel of the clock signal is spread through the clock buffer.

In an example, the clock buffer has an input end and 40 output ends, which may achieves inputting one signal and outputting 40 clock signals, thereby an outputting channel of the clock signal is spread. In this way, clock signals may be input to the vast majority of components of the server.

In the embodiment of the present application, the clock generator is further connected to a crystal oscillator.

The crystal oscillator may generate an oscillation frequency and generate highly stable signals, making the clock signal generated by the clock generator more stable.

In the embodiment of the present application, the output end of the clock generator is connected to the input end of the clock buffer, and the output end of the clock buffer is connected to the configuration component of the server.

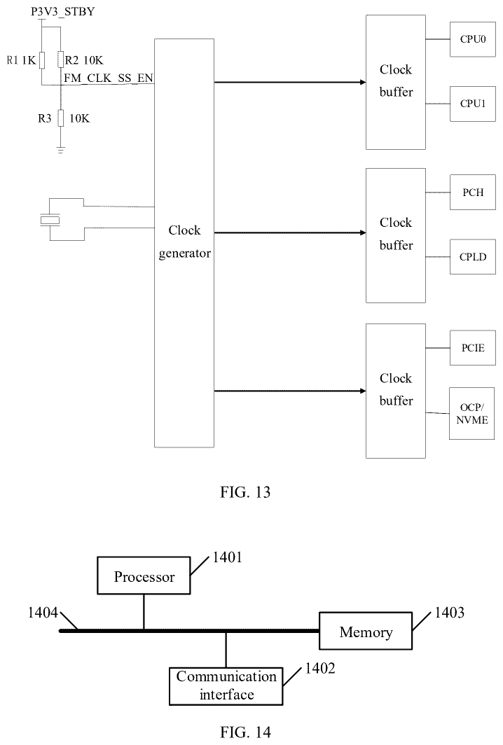

In the embodiment of the present application, the output end of the clock generator in the spread spectrum system for the server is connected to the input end of the clock buffer, and the output end of the clock buffer is connected to the configuration component of the server. Referring to FIG. 13, a structural diagram of another spread spectrum system for a server according to an embodiment of the present application is shown. If a configuration component which generates electromagnetic interference exists in the server, such as an OCP card, an NVME, and a PCIe, a spread spectrum function may be enabled for the server.

In the embodiment of the present application, the spread spectrum system for the server includes a clock generator and a clock buffer. An output end of the clock generator is connected to an input end of the clock buffer, and an output end of the clock buffer is connected to a configuration component, which does not generate electromagnetic interference, in the server. The output end of the clock generator is further connected to the configuration component, which generates electromagnetic interference, in the server. The clock generator is configured to spread a clock signal generated by the clock generator by changing an input signal of the clock generator, so as to provide the clock signal by separately using one clock generator when the configuration component which generates electromagnetic interference exists in the server. This ensures that the configuration component may satisfy an electromagnetic compatibility test and pass a systematic test, without enabling or disabling the spread spectrum function of the entire machine.

It should be noted that for the method embodiment, for the sake of simple description, they are all described as a series of action combinations. However, those skilled in the art should be aware that the embodiments of the present application are not limited by the order of the described actions, as according to the embodiments of the present application, certain steps may be performed in other orders or simultaneously. Secondly, those skilled in the art should also be aware that the embodiments described in this specification are all embodiments, and the actions involved may not be necessary for the embodiments of the present application.

In addition, an electronic device is further provided by the embodiments of the present application, as shown in FIG. 14, including: a processor 1401, a communication interface 1402, a memory 1403, and a communication bus 1404. The processor 1401, the communication interface 1402, and the memory 1403 complete mutual communications through the communication bus 1404.

The memory 1403 is configured to store a computer program.

The processor 1401 is configured to execute the program stored on the memory 1403 to implement the following steps:
determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency;
writing the mapping information into a basic input output system program;
in response to the server being powered on, determining a configuration component, having an electromagnetic radiation frequency exceeding a preset electromagnetic radiation threshold, in the server to be a target configuration component; and
according to the mapping information that is written into the basic input output system program, determining the spread spectrum amplitude and the spread spectrum form which correspond to the target configuration component, and enabling a spread spectrum function for the target configuration component.

In some embodiments, the method further includes:
in response to the server being powered on, determining the configuration component, having the electromagnetic radiation frequency exceeding the preset electromagnetic radiation threshold, in the server to be the target configuration component; and
according to the mapping information that is written into the basic input output system program, determining the spread spectrum amplitude and the spread spectrum form which correspond to the server, and enabling a spread spectrum function for the server.

In some embodiments, after the step of according to the mapping information that is written into the basic input output system program, determining the spread spectrum amplitude and the spread spectrum form which correspond to the server, and enabling the spread spectrum function for the server, the method further includes:
setting a menu item for enabling and disabling spread spectrum in the basic input output system program.

In some embodiments, after the step of according to the mapping information that is written into the basic input output system program, determining the spread spectrum amplitude and the spread spectrum form which correspond to the target configuration component, and enabling the spread spectrum function for the target configuration component, the method further includes:
setting a menu item for enabling and disabling spread spectrum in the basic input output system program.

In some embodiments, the method further includes:
when the server is powered on, in response to determining that the target configuration component does not exist in the server, setting the menu item for enabling and disabling spread spectrum in the basic input output system program.

In some embodiments, the method further includes:
manually enabling or disabling spread spectrum through the menu item.

In some embodiments, the server has an IIO port. The IIO port is connected to different configuration components. The method further includes:
by automatically scanning the IIO port, determining, in a cross validation way, whether the configuration component connected to the IIO port is the target configuration component.

In some embodiments, the spread spectrum form includes up spread, center spread and down spread.

A spread spectrum amplitude and a spread spectrum form which are required by each of the at least one configuration component in the server and a spread spectrum amplitude and a spread spectrum form which are required by the server are determined, and mapping information is generated according to identification information, the spread spectrum amplitudes, and the spread spectrum forms corresponding to the at least one configuration component, wherein the mapping information is determined based on an electromagnetic radiation frequency;
the mapping information is written into a basic input output system program;
in response to the server being powered on, a configuration component, having an electromagnetic radiation frequency exceeding a preset electromagnetic radiation threshold, in the server is determined to be a target configuration component according to the identification information; and
the spread spectrum amplitude and the spread spectrum form which correspond to the target configuration component are determined according to the mapping information that is written into the basic input output system program, and a spread spectrum function is enabled for the target configuration component.

In some embodiments, the method further includes:
in response to the server being powered on, determining a configuration component, having an electromagnetic radiation frequency exceeding a preset electromagnetic radiation threshold, in the server to be a target configuration component; and
according to the mapping information that is written into the basic input output system program, the spread spectrum amplitude and the spread spectrum form which correspond to the server are determined, and a spread spectrum function is enabled for the server.

In some embodiments, after the step of according to the mapping information that is written into the basic input output system program, determining the spread spectrum amplitude and the spread spectrum form which correspond to the server, and enabling the spread spectrum function for the server, the method further includes:
setting a menu item for enabling and disabling spread spectrum in the basic input output system program.

In some embodiments, after the step of according to the mapping information that is written into the basic input output system program, determining the spread spectrum amplitude and the spread spectrum form which correspond to the target configuration component, and enabling the spread spectrum function for the target configuration component, the method further includes:
setting a menu item for enabling and disabling spread spectrum in the basic input output system program.

In some embodiments, the method further includes:
when the server is powered on, in response to determining that the target configuration component does not exist in the server, setting the menu item for enabling and disabling spread spectrum in the basic input output system program.

Different preset electromagnetic radiation thresholds are set for different shipping locations;
a spread spectrum amplitude and a spread spectrum form which correspond to a configuration component in the server and a spread spectrum amplitude and a spread spectrum form which correspond to the server are determined, and mapping information is generated, wherein the mapping information is determined based on an electromagnetic radiation frequency;
the mapping information is written into a basic input output system program;
in response to the server being powered on, whether a configuration component having an electromagnetic radiation frequency exceeding the electromagnetic radiation threshold exists in the server is determined; and
in response to the configuration component having the electromagnetic radiation frequency exceeding the electromagnetic radiation threshold existing in the server, the spread spectrum amplitude and the spread spectrum form which correspond to the server are determined according to the mapping information that is written into the basic input output system program, and a spread spectrum function is enabled for the server.

The communication bus mentioned in the above terminal may be a peripheral component interconnect (PCI) bus, an extended industry standard architecture (EISA) bus, or the like. The communication bus may be classified into an address bus, a data bus, a control bus, and the like. For ease of representation, only one thick line is used in the figure, but it does not mean that there is only one bus or one type of bus.

The communication interface is configured to achieve communication between the above terminal and another device.

The memory may include a random access memory (RAM), and may further include a non-transitory memory, such as at least one disk memory. In some embodiments, the memory may also be a storage apparatus located away from the foregoing processor.

The above processor may be a general-purpose processor, including a central processing unit (CPU), a network processor (NP), and the like. It may also be a digital signal processing (DSP), an application integrated circuit (ASIC), a field-programmable gate array (FPGA), or other programmable logic devices, discrete gates or transistor logic devices, or discrete hardware components.

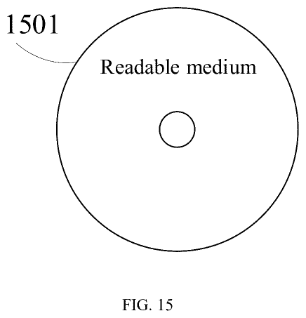

As shown in FIG. 15, a non-transitory computer-readable storage medium 1501 is further provided in another embodiment provided in the present application, the non-transitory computer-readable storage medium has instructions stored thereon. The instructions, when executed on a computer, cause the computer to perform the spread spectrum method for the server in the above embodiment.

A computer program product including instructions is further provided in yet another embodiment of the present application. When the computer program product is run on a computer, the computer is caused to perform the spread spectrum method for the server in the above embodiment.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer program instructions are loaded and executed on a computer, flows or functions according to the embodiments of the present application are all or partially generated. The computer may be a general-purpose computer, a special-purpose computer, a computer network, or other programmable apparatuses. The computer instructions may be stored in a non-transitory computer-readable storage medium or may be transmitted from one non-transitory computer-readable storage medium to another non-transitory computer-readable storage medium. For example, the computer instructions may be transmitted from a website, a computer, a server, or a data center to another website, computer, server, or data center in a wired manner (for example, by using a coaxial cable, an optical fiber, or a digital subscriber line (DSL)) or a wireless (for example, infrared, radio, or microwave) manner. The non-transitory computer-readable storage medium may be any usable medium that may be accessed by the computer, or a data storage device, for example, a server or a data center, integrating one or more usable media. The usable medium may be a magnetic medium (for example, a floppy disk, a hard disk, or a magnetic tape), an optical medium (for example, digital versatile disc (DVD)), a semiconductor medium (for example, solid state disk (SSD)), or the like.

It should be noted that in this document, relationship terms such as first and second are used solely to distinguish one entity or operation from another entity or operation without necessarily requiring or implying any actual such relationship or order between these entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without more constraints, an element limited by “includes a . . . ” does not preclude the existence of additional identical elements in the process, method, product, or device that includes the element.

The various embodiments in the present specification are described in relevant ways, and the same and similar parts between the various embodiments may be referred to each other. Each embodiment focuses on differences from other embodiments. Particularly, the system embodiment is basically similar to the method embodiment, and therefore is described briefly. For related parts, some of the descriptions in the method embodiment are referred to.

The foregoing descriptions are not intended to limit the protection scope of the present application. Any modification, equivalent replacement and improvement made within the spirit and scope of the present application shall fall within the protection scope of the present application.

1. A spread spectrum method for a server, wherein the server comprises at least one configuration component, and the method comprises:
determining a spread spectrum amplitude and a spread spectrum form which are required by each of the at least one configuration component in the server and a spread spectrum amplitude and a spread spectrum form which are required by the server, and generating mapping information, wherein the mapping information is determined based on an electromagnetic radiation frequency;
writing the mapping information into a basic input output system program;
in response to the server being powered on, determining a configuration component, having an electromagnetic radiation frequency exceeding a preset electromagnetic radiation threshold, in the server to be a target configuration component; and
according to the mapping information that is written into the basic input output system program, determining the spread spectrum amplitude and the spread spectrum form which correspond to the target configuration component, and enabling a spread spectrum function for the target configuration component.

2. The method according to claim 1, wherein the method further comprises:
in response to the server being powered on, determining the configuration component, having the electromagnetic radiation frequency exceeding the preset electromagnetic radiation threshold, in the server to be the target configuration component; and
according to the mapping information that is written into the basic input output system program, determining the spread spectrum amplitude and the spread spectrum form which correspond to the server, and enabling a spread spectrum function for the server.

3. The method according to claim 2, wherein after the step of according to the mapping information that is written into the basic input output system program, determining the spread spectrum amplitude and the spread spectrum form which correspond to the server, and enabling the spread spectrum function for the server, the method further comprises:
setting a menu item for enabling and disabling spread spectrum in the basic input output system program.

4. The method according to claim 1, wherein after the step of according to the mapping information that is written into the basic input output system program, determining the spread spectrum amplitude and the spread spectrum form which correspond to the target configuration component, and enabling the spread spectrum function for the target configuration component, the method further comprises:
setting a menu item for enabling and disabling spread spectrum in the basic input output system program.

5. The method according to claim 4, wherein the method further comprises:
when the server is powered on, in response to determining that the target configuration component does not exist in the server, setting the menu item for enabling and disabling spread spectrum in the basic input output system program.

6. The method according to claim 5, wherein the method further comprises:
manually enabling or disabling spread spectrum through the menu item.

7. The method according to claim 1, wherein the server has an integrated input/output (IIO) port; the IIO port is connected to different configuration components; and the method further comprises:
by automatically scanning the IIO port, determining, in a cross validation way, whether the configuration component connected to the IIO port is the target configuration component.

8. The method according to claim 1, wherein the spread spectrum form comprises up spread, center spread and down spread.

9. A spread spectrum method for a server, wherein the server comprises at least one configuration component; the configuration component has identification information; and the method comprises:
determining a spread spectrum amplitude and a spread spectrum form which are required by each of the at least one configuration component in the server and a spread spectrum amplitude and a spread spectrum form which are required by the server, and generating mapping information according to the identification information, the spread spectrum amplitudes and the spread spectrum forms corresponding to the at least one configuration component, wherein the mapping information is determined based on an electromagnetic radiation frequency;
writing the mapping information into a basic input output system program;
in response to the server being powered on, according to the identification information, determining a configuration component, having an electromagnetic radiation frequency exceeding a preset electromagnetic radiation threshold, in the server to be a target configuration component; and
according to the mapping information that is written into the basic input output system program, determining the spread spectrum amplitude and the spread spectrum form which correspond to the target configuration component, and enabling a spread spectrum function for the target configuration component.

10. The method according to claim 9, wherein the method further comprises:
in response to the server being powered on, determining the configuration component, having the electromagnetic radiation frequency exceeding the preset electromagnetic radiation threshold, in the server to be the target configuration component; and
according to the mapping information that is written into the basic input output system program, determining the spread spectrum amplitude and the spread spectrum form which correspond to the server, and enabling a spread spectrum function for the server.

11. The method according to claim 10, wherein after the step of according to the mapping information that is written into the basic input output system program, determining the spread spectrum amplitude and the spread spectrum form which correspond to the server, and enabling the spread spectrum function for the server, the method further comprises:
setting a menu item for enabling and disabling spread spectrum in the basic input output system program.

12. The method according to claim 9, wherein after the step of according to the mapping information that is written into the basic input output system program, determining the spread spectrum amplitude and the spread spectrum form which correspond to the target configuration component, and enabling the spread spectrum function for the target configuration component, the method further comprises:
setting a menu item for enabling and disabling spread spectrum in the basic input output system program.

13. The method according to claim 12, wherein the method further comprises:
when the server is powered on, in response to determining that the target configuration component does not exist in the server, setting the menu item for enabling and disabling spread spectrum in the basic input output system program

14. (canceled)

15. A spread spectrum system for a server, comprising a clock generator and a clock buffer, wherein an output end of the clock generator is connected to an input end of the clock buffer; an output end of the clock buffer is connected to a configuration component which does not generate electromagnetic interference in the server; the output end of the clock generator is further connected to a configuration component which generates electromagnetic interference in the server; and
the clock generator is configured to spread a clock signal generated by the clock generator by changing an input signal of the clock generator.

16. The system according to claim 15, wherein the clock generator is connected to a direct-current voltage through a plurality of resistors; and a voltage of the input signal of the clock generator is changed by changing connection relationships among the plurality of resistors.

17. The system according to claim 16, wherein the clock generator is connected to the direct-current voltage through a slide rheostat; and the voltage of the input signal of the clock generator is changed by changing a resistance value of the slide rheostat.

18. The system according to claim 15, wherein the clock buffer has an input end and a plurality of output ends; and an outputting channel of the clock signal is spread through the clock buffer.

19. The system according to claim 15, wherein the clock generator is further connected to a crystal oscillator.

20. An electronic device, comprising: a processor, a communication interface, a memory and a communication bus, wherein the processor, the communication interface and the memory complete mutual communications through the communication bus;
the memory is configured to store a computer program; and
the processor is configured to in response to executing the computer program stored on the memory, implement the method according to claim 1.

21. A non-transitory computer-readable storage medium, having instructions stored thereon, wherein the instructions, in response to being executed by one or more processors, cause the one or more processors to implement the method according to claim 1.
